(19) United States
(12) Patent Application Publication
(10) Pub. No.: US 2025/0310096 A1
(43) Pub. Date: Oct. 2, 2025

(54) DYNAMIC REGISTRATION OF INTERNET-OF-THINGS (IoT) DEVICES USING A TRANSFERABLE IoT DEVICE NETWORK

(71) Applicant: International Business Machines Corporation, Armonk, NY (US)

(72) Inventors: Eric B. Libow, Raleigh, NC (US); Ajit Jariwala, Cary, NC (US); Thomas Scott Wallace, Hillsborough, NC (US); Jackson P Leonard, Austin, TX (US)

(21) Appl. No.: 18/617,970

(22) Filed: Mar. 27, 2024

(51) Int. Cl. H04L 9/08

(52) U.S. Cl. CPC H04L 9/088

(57) ABSTRACT

According to one embodiment, a method, computer system, and computer program product for transferring control of a plurality of Internet-of-Things (IoT) devices within a physical location is provided. The embodiment may include accessing network-layer (NL) configuration parameters of a device service set identifier (SSID), a private key of the device SSID, and device configuration data of a plurality of IoT devices associated with the device SSID. The embodiment may include adding the device SSID as an additional network of a wireless router. The embodiment may include connecting the plurality of IoT devices to the device SSID using the private key. The embodiment may include configuring settings of the plurality of IoT devices based on the device configuration data.

### BACKGROUND

The present invention relates generally to the field of computing, and more particularly to Internet-of-Things (IoT) device registration.

The IoT describes devices embedded with sensors, processing ability, software, and other technologies that connect and exchange data with other devices and systems over the internet or other communications network. These devices may range from everyday items such as household appliances, wearable devices, and vehicles to industrial machines, infrastructure components, and more. In the consumer market, IoT devices are most associated with smart home products (e.g., lighting fixtures, thermostats, security systems, doorbells, cameras, and other home appliances) that support an ecosystem and can be controlled via devices (e.g., smartphones and smart speakers) associated with that ecosystem. IoT device registration refers to the process of enrolling a device onto a network or platform and enabling it to communicate and interact with other IoT devices or systems of the network. The prevalence of IoT devices has been rapidly increasing due, in part, to a proliferation of connected devices across various industries and sectors.

### SUMMARY

According to one embodiment, a method, computer system, and computer program product for transferring control of a plurality of Internet-of-Things (IoT) devices within a physical location is provided. The embodiment may include accessing network-layer (NL) configuration parameters of a device service set identifier (SSID), a private key of the device SSID, and device configuration data of a plurality of IoT devices associated with the device SSID. The embodiment may include adding the device SSID as an additional network of a wireless router. The embodiment may include connecting the plurality of IoT devices to the device SSID using the private key. The embodiment may include configuring settings of the plurality of IoT devices based on the device configuration data.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computer environment according to at least one embodiment.

FIG. 2 illustrates an operational flowchart for establishing a device network for a plurality of Internet-of-Things (IoT) devices within a physical location via an IoT device transfer set-up process, according to at least one embodiment.

FIG. 3 illustrates an operational flowchart for transferring control of a plurality of IoT devices within a physical location to another user via an IoT device transfer process, according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

The present invention relates generally to the field of computing, and more particularly to Internet-of-Things (IoT) device registration. The following described exemplary embodiments provide a system, method, and program product to, among other things, allow an owner/administrator of a network of IoT devices to transfer ownership/control to another user while preserving configurations of the network and of the IoT devices. Therefore, the present embodiment has the capacity to improve the technical field of IoT device registration by dynamically facilitating the transfer of configurations of a subnetwork of IoT devices within a location to a network of a new administrative/owning user while maintaining relationships between the IoT devices and the network, thus avoiding the need to individually re-configure and re-authenticate the IoT devices within the location.

As previously described, the IoT describes devices embedded with sensors, processing ability, software, and other technologies that connect and exchange data with other devices and systems over the internet or other communications network. These devices may range from everyday items such as household appliances, wearable devices, and vehicles to industrial machines, infrastructure components, and more. In the consumer market, IoT devices are most associated with smart home products (e.g., lighting fixtures, thermostats, security systems, doorbells, cameras, and other home appliances) that support an ecosystem and can be controlled via devices (e.g., smartphones and smart speakers) associated with that ecosystem. IoT device registration refers to the process of enrolling a device onto a network or platform and enabling it to communicate and interact with other IoT devices or systems of the network. The prevalence of IoT devices has been rapidly increasing due, in part, to a proliferation of connected devices across various industries and sectors.

As mentioned above, the growing popularity of the IoT is evident across a wide range of sectors as organizations and consumers embrace these connected devices to drive innovation, efficiency, and convenience in various aspects of business operations and daily life. For instance, many locations (e.g., homes, apartments, office buildings, hotels, hospitals) may contain integrated IoT devices for security purposes (e.g., smart locks, cameras, and motion sensors) as well as for enablement of automations or “smart” capabilities within the location (e.g., smart lights, smart thermostats, and smart appliances). In many cases, these integrated IoT devices may be configured in such a way that they are associated with a specific user account (e.g., a homeowner's account or a renter's account) hosted on a third-party cloud service provider. As such, the process of transferring ownership/control of these IoT devices to a new user (e.g., a new homeowner or a new renter) is made difficult as the previous user must first de-register these devices and then the new user must manually configure, under their own account, each IoT device. Furthermore, during this process of ownership/control transfer, any existing network-layer parameters (e.g., IoT device groupings, device settings, home location data, etc.) are typically lost as they are considered to be information of the previous user. It may therefore be imperative to have an IoT device transfer system in place to provide for dynamic transfer of ownership/control of IoT devices within a location from a previous user to a new user while maintaining existing network-layer parameters of the IoT devices. Thus, embodiments of the present invention may be advantageous to, among other things, maintain configurations (e.g., settings) of respective IoT devices within a location during a transfer of ownership/control of the IoT devices, maintain configurations of a device network (e.g., a service set identifier (SSID) associated with IoT devices of a location during a transfer of ownership/control of the IoT devices, define a unique SSID as a device network for IoT devices of a location, generate a password and a private key of a device network to establish connections with IT devices of the device network, overlay configurations of a device network of IoT devices of a location onto a network of a user, utilize a physical media or quick response (QR) code to store configuration data of a device network, configuration data of IoT devices of the device network, and a private key of the device network, automatically register IoT devices of a location to an account of a new user in response to adding device network data onto a network of the new user, remove access and management by a previous user to a device network for IoT devices of a location, and enable control/management of IoT devices of a location via a network of a new user. The present invention does not require that all advantages need to be incorporated into every embodiment of the invention.

According to at least one embodiment, in response to a transfer of ownership/control of a plurality of IoT devices within a physical location to a new user, an IoT device transfer (IoT-DT) program may receive, from a router, data of a device network associated with the plurality of IoT devices. The data of the device network may include network-layer (NL) configuration parameters of the device network, device configuration data for each IoT device of the plurality of IoT devices, as well as a private key of the device network. According to at least one embodiment, the NL configuration parameters, the device configuration data, and the private key may be stored on a physical media interfaced with the router, which is in communication with, and managed by, the IoT-DT program. According to at least one embodiment, the IoT-DT program may overlay (i.e., define) the device network as an additional network of the router. The IoT-DT program may then enable connectivity of the plurality of IoT devices to the device network while maintaining existing configurations/settings of the plurality of IoT devices.

According to at least one other embodiment, as part of an IoT device transfer set-up phase, the IoT-DT program may define a unique device network (e.g., a unique SSID), with corresponding NL configuration parameters, for a plurality of IoT devices within a physical location and register the plurality of IoT devices with the defined device network. The IoT devices may be integrated within the physical location and may be individually configured to connect to the defined device network and perform their respective operations via the defined device network. As part of the registration, the IoT-DT program may receive device configuration data for each IoT device of the plurality. Additionally, the IoT-DT program may generate a private key/password which enables access (i.e., connectivity) to the defined device network. Furthermore, according to the at least one other embodiment, the IoT-DT program may store the NL configuration parameters of the device network, the device configuration data for each IoT device of the plurality, as well as the private key of the device network on a physical media (e.g., a universal serial bus (USB) drive or a micro memory card) which may be interfaced with a wireless network router.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to allow ownership/control of a network of IoT devices within a physical location to be transferred to from a previous user to a new user while maintaining configurations of the IoT devices and connectivity between the IoT devices and the network.

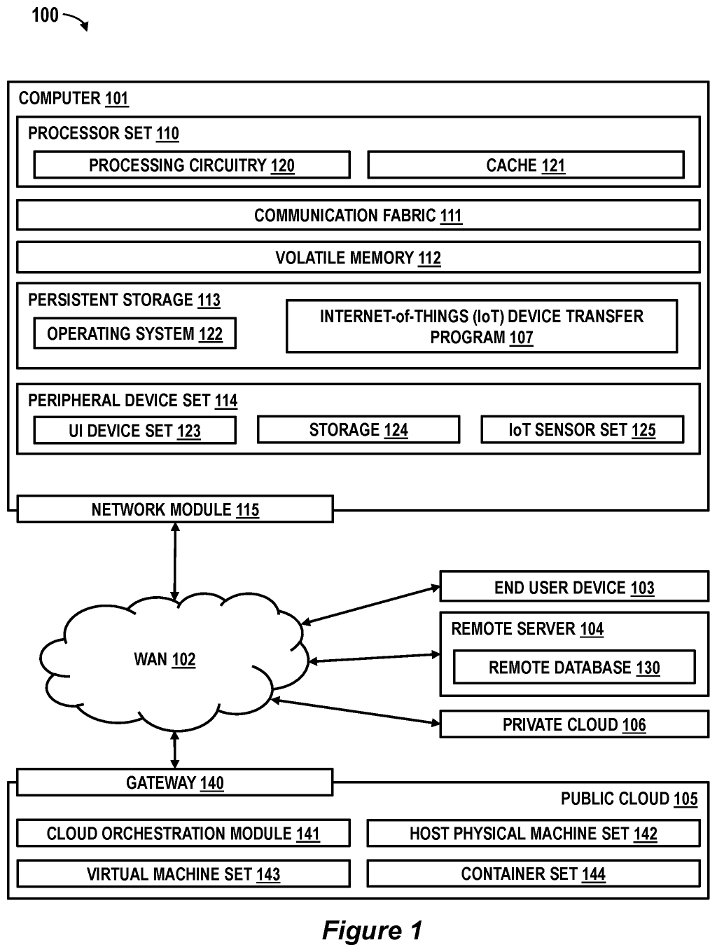

Referring to FIG. 1, an exemplary computing environment 100 is depicted, according to at least one embodiment. Computing environment 100 contains an example of an environment for the execution of at least some of the computer code involved in performing the inventive methods, such as IoT device transfer (IoT-DT) program 107. In addition to IoT-DT program 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and IoT-DT program 107), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smartphone, smart watch or other wearable computer, mainframe computer, quantum computer or any other form of computer or mobile device now known or to be developed in the future that is capable of running a program and accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in IoT-DT program 107 within persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in IoT-DT program 107 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as smart glasses, smart watches, AR/VR-enabled headsets, and wearable cameras), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, another sensor may be a motion detector, another sensor may be a global positioning system (GPS) receiver, another sensor may be a smart lock, and yet another sensor may be a digital image capture device (e.g., a camera) capable of capturing and transmitting one or more still digital images or a stream of digital images (e.g., digital video).

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network or a mesh network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a client of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on. According to at least one other embodiment, in addition to taking any of the forms discussed above with computer 101, EUD 103 may further be an IoT device capable of connecting to computer 101 via WAN 102 and network module 115 and capable of receiving instructions from IoT-DT program 107. Also, according to yet another embodiment, EUD 103 may further be a wireless network router capable of interfacing with a physical memory media, capable of connecting to computer 101 via WAN 102 and network module 115, and capable of receiving instructions from IoT-DT program 107.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

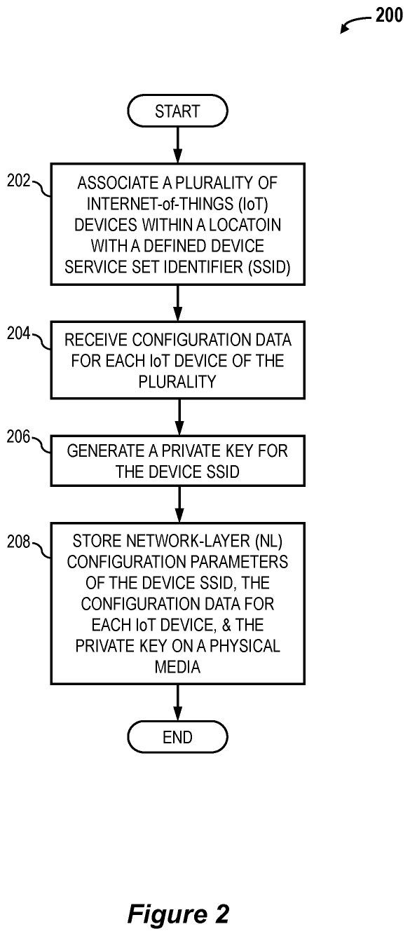

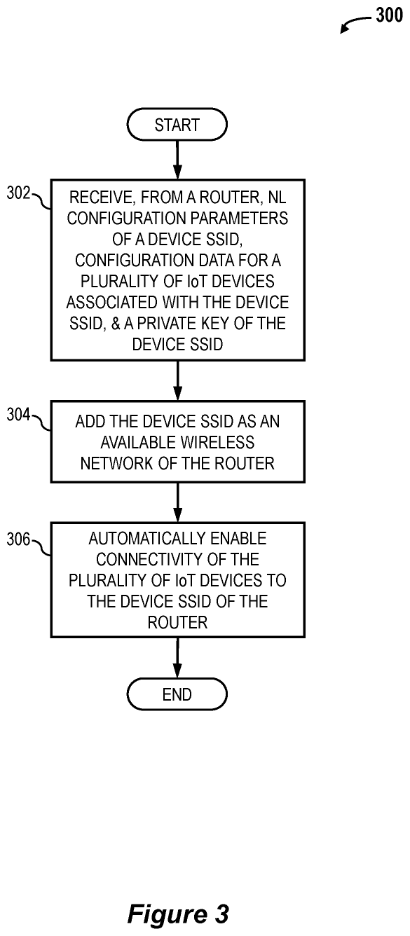

The IoT-DT program 107 may be a program capable of maintaining configurations (e.g., settings) of respective IoT devices within a location during a transfer of ownership/control of the IoT devices, maintaining configurations of a device network (e.g., a service set identifier (SSID) associated with IoT devices of a location during a transfer of ownership/control of the IoT devices, defining a unique SSID as a device network for IoT devices of a location, generating a password/private key of a device network to establish connections with IoT devices of the device network, overlaying configurations of a device network of IoT devices of a location onto a network of a user, utilizing a physical media or quick response (QR) code to store configuration data of a device network, configuration data of IoT devices of the device network, and a private key of the device network, automatically registering IoT devices of a location to an account of a new user in response to adding device network data onto a network of the new user, removing access and management by a previous user to a device network for IoT devices of a location, and enabling control/management of IoT devices of a location via a network of a new user. In at least one embodiment, IoT-DT program 107 may require a user to opt-in to system usage upon opening or installation of IoT-DT program 107, or upon requesting access to a wireless network managed by IoT-DT program 107. Notwithstanding depiction in computer 101, IoT-DT program 107 may be stored in and/or executed by, individually or in any combination, end user device 103, remote server 104, public cloud 105, and private cloud 106 so that functionality may be separated among the devices. The IoT device transfer method is explained in further detail below with respect to FIGS. 2 and 3.

Referring now to FIG. 2, an operational flowchart for establishing a device network for a plurality of IoT devices within a physical location via an IoT device transfer set-up process 200 is depicted according to at least one embodiment. At 202, IoT-DT program 107 defines a unique service set identifier (SSID) for use as a wireless network (i.e., a device SSID) for a plurality of IoT devices within a physical location. IoT-DT program 107 may also define network-layer (NL) configuration parameters (e.g., IP address, subnet mask, default gateway, routing tables and protocols, firewall rules, etc.) for the device SSID and manage the device SSID. According to at least one embodiment, IoT devices of the plurality may be associated with the device SSID and may be individually configured to connect to, and be managed by, the device SSID. Furthermore, the IoT devices of the plurality may be integrated within the physical location. For example, the plurality of IoT devices may include, but are not limited to, smart lights, a smart thermostat, smart locks, smart speakers, and smart appliances which may be integrated within, or otherwise immovable from, the physical location (e.g., a building, a home, or an apartment) and may be configured to automatically connect to the device SSID.

Next, at 204, IoT-DT program 107 receives device configuration data for each IoT device of the plurality. According to at least one embodiment, the received device configuration data may include information regarding, but limited to, respective IoT device automation settings, respective IoT device designations and/or location designations within the physical location, IoT device groupings within the plurality, home location data, and relationships between IoT devices of the plurality. According to at least one embodiment, IoT-DT program 107 may receive the device configuration data for each IoT device of the plurality from an administrative user during initialization of the device SSID.

At 206, IoT-DT program 107 generates a private key for the device SSID. According to at least one embodiment, the generated private key may be used for establishing connectivity to the device SSID by the plurality of IoT devices within the physical location. Additionally, the private key for the device SSID may be generated according to a standard format. For example, IoT-DT program 107 may generate the private key as a PKCS #12file, with a corresponding password to encrypt the contents of the file and prevent unauthorized access to private key, or as a key-file that contains the generated private key.

Next, at 208, IoT-DT program 107 stores the NL configuration parameters for the device SSID, the device configuration data for each IoT device of the plurality, and the private key for the device SSID on a physical media. As mentioned above, IoT-DT program 107 may generate the private key in a known standard format such as a public-key cryptography standards (PKCS) #12file or as a key-file. In addition, IoT-DT program 107 may store the NL configuration parameters for the device SSID and the device configuration data for each IoT device of the plurality within a known standard format, such as within a YAML configuration file or within a JavaScript object notation (JSON) object. According to at least one embodiment, IoT-DT program 107 may store the PKCS #12file or key-file, containing the private key of the device SSID, and the YAML configuration file or the JSON object, containing the NL configuration parameters for the device SSID and the device configuration data for each IoT device of the plurality, on a physical media such as a USB drive or a micro memory card. According to at least one other embodiment, IoT-DT program 107 may store the NL configuration parameters for the device SSID and the device configuration data for each IoT device of the plurality within a software link or within a QR code which may be later accessed/read by IoT-DT program 107. According to yet another embodiment, depending on respective capabilities of IoT devices of the plurality, respective device configuration data for an IoT device of the plurality may be stored on the IoT device itself and accessed by IoT-DT program 107.

Referring now to FIG. 3, an operational flowchart for transferring control of a plurality of IoT devices within a physical location to another user via an IoT device transfer process 300 is depicted according to at least one embodiment. The plurality of IoT devices may be the plurality of IoT devices within the physical location discussed above with regard to process 200. As such, the plurality of IoT devices may be configured for connectivity with the device SSID defined in process 200. Furthermore, the private key of the device SSID, the NL configuration parameters for the device SSID, and the device configuration data for each IoT device of the plurality may be stored on a physical media such as a USB drive, as discussed above with regard to process 200. The following steps of process 300 may be performed in response to a transfer of control of the plurality of IoT devices within the physical location from a previous user to a new user.

At 302, IoT-DT program 107 receives, from a router of the new user, the NL configuration parameters of the device SSID defined in process 200 as well as the device configuration data for each IoT device of the plurality and the private key of the device SSID. According to at least one embodiment, the new user may be assuming ownership and/or control of the physical location, having the integrated plurality of IoT devices, from the previous user. Accordingly, control (i.e., management) of the plurality of IoT devices within the physical location may also be transferred from the previous user to the new user. Moreover, the new user may provide their own wireless network within the physical location via their own wireless router. In such an embodiment, the new user may receive the physical media (e.g., the USB drive) from the previous user and interface (i.e., connect) the physical media with the router, which is in communication with, and capable of being configured by, IoT-DT program 107. IoT-DT program 107 may access, from the physical media, the private key of the SSID, stored as a PKCS #12file or a key-file, as well as the NL configuration parameters for the device SSID and the device configuration data for each IoT device of the plurality, stored as a YAML configuration file or a JSON object.

Next, at 304, IoT-DT program 107 adds the device SSID as an available wireless network of the router. According to at least one embodiment, based on the NL configuration parameters for the device SSID accessed from the physical media, IoT-DT program 107 may create the device SSID as a separate wireless network on the router. The created device SSID may be in addition to any other SSID network the new user has defined on the router, such as a default SSID network. Furthermore, in creating the device SSID as an additional network to a default SSID of the router, IoT-DP program 107 may prevent the IoT devices of the plurality from connecting to the default SSID and thereby reduce the load on the default SSID network. According to at least one other embodiment, IoT-DT program 107 may create the device SSID as a hidden network known only to the IoT devices of the plurality.

At 306, IoT-DT program 107 automatically enables connectivity of the plurality of IoT devices within the physical location to the device SSID created on the router. According to at least one embodiment, utilizing the private key of the device SSID accessed from the physical media, IoT-DT program 107 may automatically connect the plurality of IoT devices within the physical location to the device SSID. Furthermore, IoT-DT program 107 may maintain existing device configurations of the plurality (e.g., respective IoT device automation settings, respective IoT device designations and/or location designations within the physical location, IoT device groupings within the plurality, home location data, and relationships between IoT devices of the plurality), as IoT-DT program 107 may also access the device configuration data for each IoT device of the plurality from the physical media. Since, as a result of process 200, the device SSID is known to the plurality of IoT devices, IoT-DT program 107 may maintain connectivity of the plurality of IoT devices as they may automatically connect to the device SSID once it is created on the router of the new user. Further, the user may manage the plurality of IoT devices within the physical location using the same interface as used to manage a default SSID. Thus, IoT-DT program 107 may prevent the plurality of IoT devices from entering an orphan state despite the introduction of a new network and their transfer of control to a new user.

Also, according to at least one other embodiment, as part of step 306, IoT-DT program 107 may automatically re-register the plurality of IoT devices under an account of the new user and disable access to the device SSID by the previous user. For example, IoT-DT program 107 may generate a new private key for the device SSID. IoT-DT program 107 may store the newly generated private key in place of the previous private key on the physical media. As another example, IoT-DT program 107 may configure the router of the new user to prevent external access (e.g., via a router-based firewall).

As an illustrative example of process 300, consider the use case of a commercial property such as an apartment building where units are rented and change tenants. A tenant would need to have exclusive ownership/control of the IoT devices integrated within their unit while they are renting. When a new tenant occupies the unit, those integrated IoT devices will need to change owner from the previous tenant to the new tenant so that the new tenant can exclusively control these devices. It is also possible that the tenants might bring their own network equipment. When a unit changes from one tenant to another the building management may provide the new tenant with a USB drive containing the IoT device network information. The new tenant may connect the USB drive to their router and IoT-DT program 107 may then add the IoT device SSID to the new tenant's network thereby allowing them to assume ownership or management of the connected IoT devices integrated within the unit. For instance, the thermostat may now be accessible to the new tenant and the old tenant will be removed from access. Control of any connected IoT devices or appliances integrated within the unit will be transferred to the new tenant while they are renting. This allows the new tenant to use existing appliances, security systems, lighting, and HVAC controls by simply adding the IoT device SSID and reassigning those devices to the new tenant.

It may be appreciated that FIGS. 2 and 3 provide only an illustration of some implementations and do not imply any limitations with regard to how different embodiments may be implemented. Many modifications to the depicted environments may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, the method comprising:
accessing network-layer (NL) configuration parameters of a device service set identifier (SSID), a private key of the device SSID, and device configuration data of a plurality of Internet-of-Things (IoT) devices associated with the device SSID;
adding the device SSID as an additional network of a wireless router;
connecting the plurality of IoT devices to the device SSID using the private key; and
configuring settings of the plurality of IoT devices based on the device configuration data.

2. The method of claim 1, further comprising:
disabling access to the device SSID by a previous user;
re-registering the plurality of IoT devices under an account of a new user;
generating a new private key of the device SSID; and
storing the new private key in place of a previous private key.

3. The method of claim 1, further comprising:
defining the device SSID, wherein the defining comprises defining the NL configuration parameters of the device SSID;
generating the private key of the device SSID;
configuring the plurality of IoT devices for connectivity with the device SSID;
receiving device configuration data for each IoT device of the plurality; and
storing the NL configuration parameters, the private key, and the device configuration data for each IoT device of the plurality on a physical media.

4. The method of claim 1, wherein the NL configuration parameters of the device SSID, the private key of the device SSID, and the device configuration data of a plurality of IoT devices associated with the device SSID are accessed from a physical media connected to the wireless router.

5. The method of claim 1, wherein the plurality of IoT devices is integrated within a physical location.

6. The method of claim 1, wherein the device configuration data of the plurality of IoT devices is selected from the group consisting of respective IoT device automation settings, respective IoT device designations and/or location designations within a physical location, IoT device groupings within the plurality, home location data, and relationships between IoT devices of the plurality.

7. The method of claim 3, wherein the NL configuration parameters and the device configuration data are stored on the physical media as a YAML configuration file or as a JavaScript object notation (JSON) object, and wherein the private key is stored on the physical media as a public-key cryptography standards (PKCS) #12 file or as a key-file.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
accessing network-layer (NL) configuration parameters of a device service set identifier (SSID), a private key of the device SSID, and device configuration data of a plurality of Internet-of-Things (IoT) devices associated with the device SSID;
adding the device SSID as an additional network of a wireless router;
connecting the plurality of IoT devices to the device SSID using the private key; and
configuring settings of the plurality of IoT devices based on the device configuration data.

9. The computer system of claim 8, wherein the method further comprises:
disabling access to the device SSID by a previous user;
re-registering the plurality of IoT devices under an account of a new user;
generating a new private key of the device SSID; and
storing the new private key in place of a previous private key.

10. The computer system of claim 8, wherein the method further comprises:
defining the device SSID, wherein the defining comprises defining the NL configuration parameters of the device SSID;
generating the private key of the device SSID;
configuring the plurality of IoT devices for connectivity with the device SSID;
receiving device configuration data for each IoT device of the plurality; and
storing the NL configuration parameters, the private key, and the device configuration data for each IoT device of the plurality on a physical media.

11. The computer system of claim 8, wherein the NL configuration parameters of the device SSID, the private key of the device SSID, and the device configuration data of a plurality of IoT devices associated with the device SSID are accessed from a physical media connected to the wireless router.

12. The computer system of claim 8, wherein the plurality of IoT devices is integrated within a physical location.

13. The computer system of claim 8, wherein the device configuration data of the plurality of IoT devices is selected from the group consisting of respective IoT device automation settings, respective IoT device designations and/or location designations within a physical location, IoT device groupings within the plurality, home location data, and relationships between IoT devices of the plurality.

14. The computer system of claim 10, wherein the NL configuration parameters and the device configuration data are stored on the physical media as a YAML configuration file or as a JavaScript object notation (JSON) object, and wherein the private key is stored on the physical media as a public-key cryptography standards (PKCS) #12 file or as a key-file.

15. A computer program product, the computer program product comprising:
one or more computer-readable tangible storage medium and program instructions stored on at least one of the one or more tangible storage medium, the program instructions executable by a processor capable of performing a method, the method comprising:
accessing network-layer (NL) configuration parameters of a device service set identifier (SSID), a private key of the device SSID, and device configuration data of a plurality of Internet-of-Things (IoT) devices associated with the device SSID;
adding the device SSID as an additional network of a wireless router;
connecting the plurality of IoT devices to the device SSID using the private key; and
configuring settings of the plurality of IoT devices based on the device configuration data.

16. The computer program product of claim 15, wherein the method further comprises:
disabling access to the device SSID by a previous user;
re-registering the plurality of IoT devices under an account of a new user;
generating a new private key of the device SSID; and
storing the new private key in place of a previous private key.

17. The computer program product of claim 15, wherein the method further comprises:
defining the device SSID, wherein the defining comprises defining the NL configuration parameters of the device SSID;
generating the private key of the device SSID;
configuring the plurality of IoT devices for connectivity with the device SSID;
receiving device configuration data for each IoT device of the plurality; and
storing the NL configuration parameters, the private key, and the device configuration data for each IoT device of the plurality on a physical media.

18. The computer program product of claim 15, wherein the NL configuration parameters of the device SSID, the private key of the device SSID, and the device configuration data of a plurality of IoT devices associated with the device SSID are accessed from a physical media connected to the wireless router.

19. The computer program product of claim 15, wherein the plurality of IoT devices is integrated within a physical location.

20. The computer program product of claim 15, wherein the device configuration data of the plurality of IoT devices is selected from the group consisting of respective IoT device automation settings, respective IoT device designations and/or location designations within a physical location, IoT device groupings within the plurality, home location data, and relationships between IoT devices of the plurality.
